(19) United States
(12) Patent Application Publication
(10) Pub. No.: US 2016/0344104 A1
(43) Pub. Date: Nov. 24, 2016

(54) Antenna Structure

(71) Applicant: Nokia Solutions and Networks Oy, Espoo (FI)

(72) Inventor: Mikko Juhani JUNTTILA, Oulu (FI)

(21) Appl. No.: 15/158,686

(22) Filed: May 19, 2016

(30) Foreign Application Priority Data
May 20, 2015 (EP) 15168360

(51) Int. Cl. H01Q 9/28; H01Q 1/48

(52) U.S. Cl. CPC H01Q 9/285; H01Q 1/48

(57) ABSTRACT

There is provided an antenna structure including a plane being substantially dielectric; a first radiator element being planar and electrically conductive, wherein the first radiator element is arranged on one side of the plane; a second radiator element being planar and electrically conductive, wherein the second radiator element is arranged on an opposite side of the plane compared with the first radiator element; a plurality of lead-trough elements penetrating through the plane and galvanically coupling the first and second radiator elements to each other, in order to form an antenna radiator, wherein the antenna radiator is arranged to radiate electromagnetic energy in accordance with an electrical input signal; and a signal feed element electrically coupled to the antenna radiator, wherein the signal feed element is arranged to transfer the electrical input signal to the antenna radiator.

### TECHNICAL FIELD

The invention relates to communications. More particularly, the invention relates to antenna structures.

### BACKGROUND

The number of terminal devices used for different communication purposes within radio communication networks is increasing. Enhancing the radio communication networks ability to handle increased number of connections may be beneficial for the performance of the network. One way to achieve this is to enhance the antennas used for the data transfer.

### BRIEF DESCRIPTION

According to an aspect, there is provided the subject matter of the independent claims. Some embodiments are defined in the dependent claims.

One or more examples of implementations are set forth in more detail in the accompanying drawings and the description below. Other features will be apparent from the description and drawings, and from the claims.

### BRIEF DESCRIPTION OF DRAWINGS

In the following embodiments will be described in greater detail with reference to the attached drawings, in which

FIGS. 1A to 1B illustrate an antenna radiator structure according to some embodiments of the invention;

FIGS. 2A to 2B illustrate some embodiments;

FIGS. 3A to 3B illustrate some embodiments;

FIGS. 4A to 4B illustrate a dipole antenna structure according to some embodiments;

FIGS. 5A to 5D illustrate some embodiments; and

FIG. 6 illustrates a block diagram according to an embodiment of the invention.

### DETAILED DESCRIPTION OF SOME EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

Embodiments described may be implemented in a radio system, such as in at least one of the following: Worldwide Interoperability for Micro-wave Access (WiMAX), Wireless Local Area Network (WLAN), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and/or 5G system. The present embodiments are not, however, limited to these systems.

The embodiments are not, however, restricted to the system given as an example but a person skilled in the art may apply the solution to other communication systems provided with necessary properties. One example of a suitable communications system is the 5G concept, as listed above. It is assumed that network architecture in 5G will be quite similar to that of the LTE-advanced. 5G is likely to use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates. 5G will likely be comprised of more than one radio access technology (RAT), each optimized for certain use cases and/or spectrum.

It should be appreciated that future networks will most probably utilize network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labor between core network operations and base station operations may differ from that of the LTE or even be non-existent. Some other technology advancements probably to be used are Software-Defined Networking (SDN), Big Data, and all-IP, which may change the way networks are being constructed and managed.

Radio communication networks, such as the Long Term Evolution (LTE), the LTE-Advanced (LTE-A) of the 3^{rd} Generation Partnership Project (3GPP), or the predicted future 5G solutions, are typically composed of at least one network element providing a cell. Each cell may be, e.g., a macro cell, a micro cell, femto, or a pico-cell, for example. The network element may be an evolved Node B (eNB) as in the LTE and LTE-A, a radio network controller (RNC) as in the UMTS, a base station controller (BSC) as in the GSM/GERAN, or any other apparatus capable of controlling radio communication and managing radio resources within a cell. For 5G solutions, the implementation may be similar to LTE-A, as described above. The network element may be a base station or a small base station, for example. In the case of multiple eNBs in the communication network, the eNBs may be connected to each other with an X2 interface as specified in the LTE. Other communication methods between the network elements may also be possible.

The cell may provide service for at least one terminal device, wherein the at least one terminal device may be located within or comprised in the cell. The at least one terminal device may communicate with devices within the network using end-to-end communication, wherein source device transmits data to the destination device via the network element and/or a core network. In order to perform this, antennas being able to transmit and/or receive electromagnetic energy on frequencies used or specified by the described communication technologies may be required.

The antennas described may be broadband antennas, for example. The antennas may be comprised in the network element, such as a base station, or in some cases in a terminal device. It may be beneficial, for example, for the antennas to have symmetric radiation pattern. This may be, however, cumbersome to achieve when using, for example, Printed Wiring Board (PWB) or Printed Circuit Board (PCB) type antennas, wherein the antenna radiator pattern may be printed on either side of the dielectric substrate. The printing may comprise etching and/or bolding, or they may be alternatives for the printing. For example, by etching, desired electric and/or dielectric patterns may be etched on the PCB. The symmetry, or more precisely enhanced symmetry, of the radiation pattern may be beneficial for the overall performance of the network, as directional antennas may be then more effectively used on desired areas and may even provide the network a longer reaching coverage. For example, performance of a MIMO type solution may be enhanced.

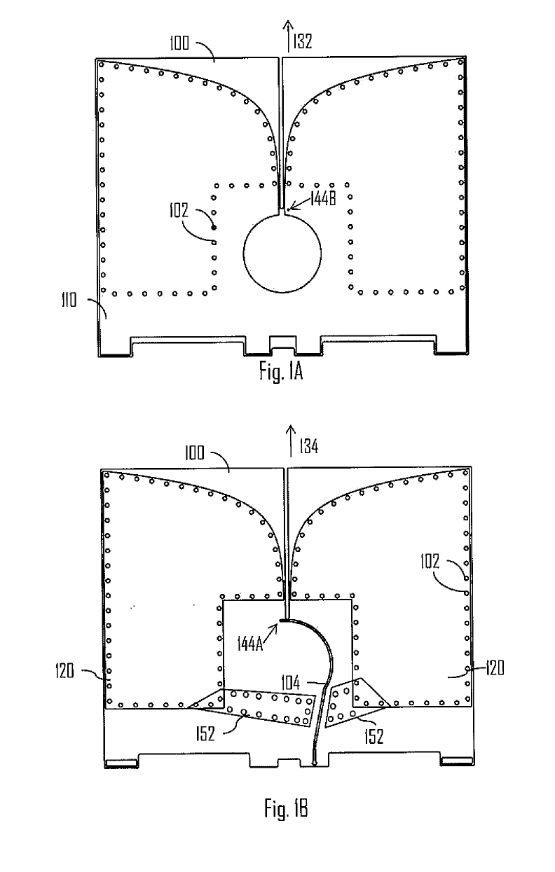

There is provided an antenna structure as shown in FIGS. 1A to 1B. The antenna structure may be usable, for example, in a network element, such as a base station, in order for the network element to receive and/or transmit electromagnetic energy via air-interface. Further, the described antenna structure may be usable in terminal devices or any device having an antenna also.

Referring to FIGS. 1A to 1B, the antenna structure may comprise a plane 100 being substantially dielectric. The plane 100 may be referred to as a base being substantially planar, for example. One side of the plane 100 may be shown in FIG. 1A and an opposite side, compared with the side shown in FIG. 1A, may be shown in FIG. 1B. The plane 100 may come in different materials and sizes. For example, the plane 100 may be and/or comprise a circuit board, such as PWB or PCB board. The plane 100 may be made of one or more pieces. Thus, the plane 100 may form an integral entity and/or it may comprise two or more pieces attached together, thus forming the plane 100. For example, it may be beneficial to use more than one circuit board in forming the plane 100.

The antenna structure may further comprise a first radiator element 110 being planar and electrically conductive, wherein the first radiator element 110 may be arranged on one side of the plane 100, as shown in FIG. 1A. The first radiator element 110 may, for example, cover most of the side of the plane 100 shown in FIG. 1A. As for the plane 100

Further, the antenna structure may comprise a second radiator element 120 being planar and electrically conductive, wherein the second radiator element 120 may be arranged on an opposite side of the plane 100 compared with the first radiator element 110. This may be shown in FIG. 1B. In a way, the first and second radiator elements 110, 120 may be against each other, but separated by the plane 100.

As shown in FIG. 1B, the second radiator element 120 may cover less area of the plane 100 than the first radiator element 110 on its side. However, it may be possible that the first and second radiator elements 110, 120 may be of same size and/or shape. It may be beneficial, however, to form one of the radiator elements 110, 120 such that there is excess space on the plane 100. This may be beneficial, for example, if a signal feed is arranged on the plane 100, as described below.

It needs to be noted that the second radiator element 120 may not necessarily be formed of an integral part. Thus, it may be formed of two or more pieces, such as two or more printed patterns on the plane 100, as shown in FIG. 1B. In an embodiment, the second radiator element 120 forms an integral entity. This means that it may be made of one substantially homogeneous substance member, such as printed copper pattern having a width, a height and a thickness. Similarly, the first radiator element 110 may be formed from one or more pieces, such as one printing pattern, or two or more printing patterns. In an embodiment, the first radiator element 110 forms an integral entity.

In an embodiment, the first and/or second radiation elements 110, 120 patterns comprise two or more members placed at least partially on top of each other. For example, the first and/or second radiation elements 110, 120 patterns may comprise an electrically conductive material covered with a dielectric substance. One example is to use copper as the electric material, and use a tin coating to cover the copper.

The second radiator element 120 may be adapted, positioned and dimensioned so that it may comprise at least those part(s) of the antenna structure which produce the majority of the electromagnetic radiation. In the example of FIGS. 1A to 1B, the majority of the electromagnetic radiation may be produced by the second radiator element 120, and by an area of the first radiator element 110 that is substantially directly on other side of the plane 100 compared with the second radiator element 120. In an embodiment, the first and second radiator elements 110, 120 are of different size and/or shape.

The antenna structure may comprise a plurality of lead-trough elements 102 penetrating through the plane and galvanically coupling the first and second radiator elements 110, 120 to each other, in order to form an antenna radiator, wherein the antenna radiator is arranged to radiate electromagnetic energy in accordance with an electrical input signal. The lead-trough elements 102 may comprise a through-hole and an electrically conductive member that is arranged to extend through the through-hole, and to electrically (e.g. galvanically in this case) couple the first and second radiator elements 110, 120 together. The through-hole may, for example, penetrate the plane 100, the first radiator element 110 and the second radiator element 120. Thus, each of the plane 100, the first radiator element 110 and the second radiator element 120 may comprise a through-hole, wherein the through-hole formed by the three through holes may be penetrated and/or filled by an electrically conductive substance, such as copper, to electrically couple the first and second radiator elements 110, 120 together. In an embodiment, the lead-through elements 102 comprise electrically conductive wire, such as copper wire, extending through the plane 100.

Coupling two pieces together galvanically may mean that the two pieces are electrically connected to each other using a physical connection between the two pieces.

The galvanic coupling of the first and second radiator elements 110, 120 may form the antenna radiator arranged to radiate electromagnetic energy. Further, the galvanic coupling between the two sides of the plane 100 may enhance symmetry of a radiation pattern of the antenna radiator. For example, if only one radiator element would be used on one side of the plane 100, the dielectric plane 100 may affect, for example, the transmission so that the radiation pattern may become lopsided, one-sided and/or squinted.

The galvanic coupling enabled by the plurality of lead-trough elements 102 may cause the electrical field within the plane 100 to be close to zero. The lead-through elements 102 may be, for example CU-VIA(s) comprised in PWB and/or PCB. To be more precise, the plurality of lead-trough elements 102 may make the first and second radiator elements 110, 120 symmetrized compared with each other, and thus enhance the symmetry of the antenna radiation pattern.

It needs to be further noted that this may mean that increasing the number and/or areal coverage of the plurality of lead-trough elements 102 may be beneficial for loss minimization purposes and/or enhancing symmetry of the radiation pattern.

In an embodiment, the plurality of lead-trough elements 102 each comprises a copper VIA (CU-VIA): Thus, the electrical coupling may be achieved using copper VIAs. Lead-through(s) may also be made from and/or comprise copper, silver, tin or any suitable conductive material.

Still referring to FIGS. 1A to 1B, the antenna structure may comprise a signal feed element 104 electrically coupled to the antenna radiator formed by the first and second radiator elements 110, 120, wherein the signal feed element 104 is arranged to transfer the electrical input signal to the antenna radiator. One way to provide the signal to the antenna radiator is to use a capacitive coupling between the signal feed element 104 and the antenna radiator. In such case, the signal feed element 104 may not necessarily touch the antenna radiator. Thus the electrical coupling between the signal feed element 104 and the antenna radiator may happen through air-interface. Another way, as shown in FIG. 1B, may be to arrange the signal feed element 104 on the plane 100, and galvanically couple the signal feed element 104 to the antenna radiator. The coupling point between the signal feed element 104 and the antenna radiator may be shown in FIGS. 1A and 1B with arrows 144A, 144B from respective sides of the plane 100. Thus, the signal feed element 104 may penetrate through the plane 100 (point shown with the arrow 144A) to couple, for example, to the first radiator element 110 (point shown with the arrow 144B).

The antenna structure shown in FIGS. 1A to 1B may be referred to as a two-sided Vivaldi antenna structure, for example. Naturally, other antenna structures, such as dipole antenna structure, may be symmetrized using described solution. Dipole antenna structure may be discussed later in more detail. The Vivaldi antenna may radiate the electromagnetic energy substantially to a direction shown with arrows 132, 134. Directivity may be enabled and/or enhanced by using an antenna reflector, for example. The radiated electromagnetic energy may be polarized, such as linear polarized electromagnetic radiation.

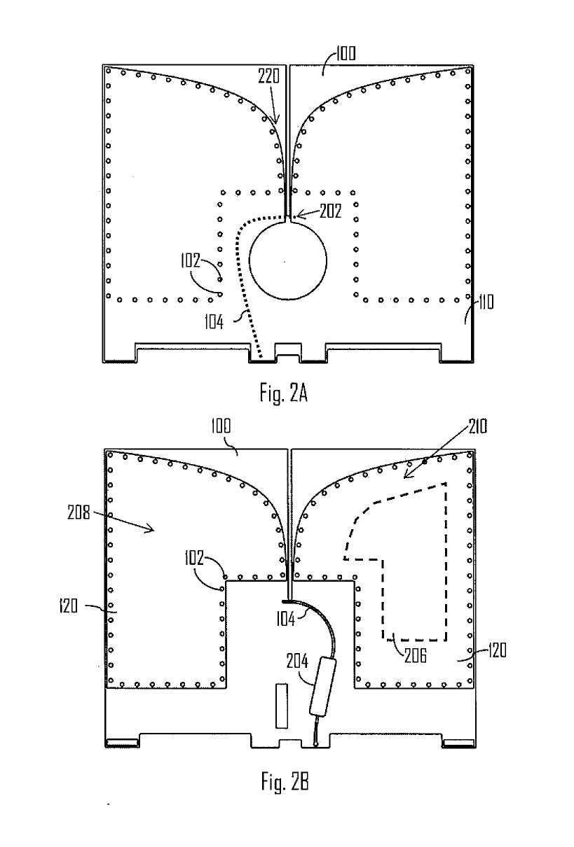

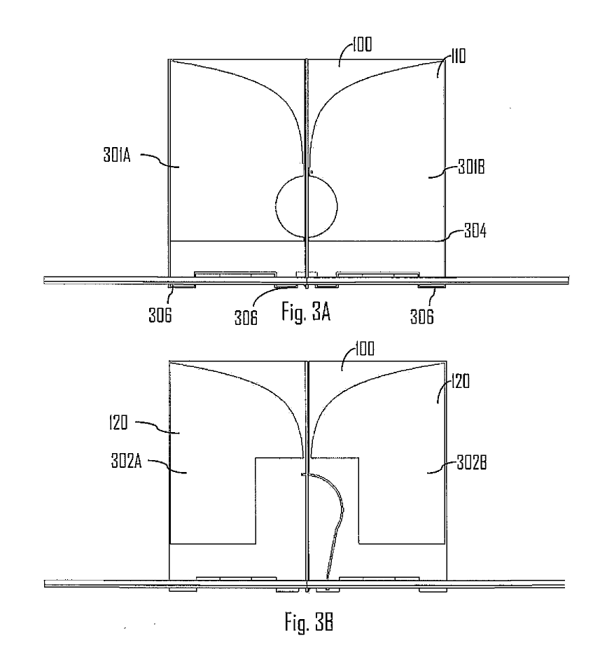

Let us now look at some embodiments of the invention with reference to FIGS. 2A to 2B. Referring to FIG. 2A to 2B, opposite sides of the plane 100 may be shown as in FIGS. 1A to 1B. The signal feed element 104 may be arranged to penetrate the plane 100. The penetration point may be shown with an arrow 202. For example, if the signal feed element 104 is arranged, such as printed or glued, on one side of the plane 100, the signal feed element 104 may penetrate the plane 100 through a hole and be connected to the antenna radiator on the opposite side of the plane 100. The signal feed element 104 may be galvanically coupled to the first radiator element 110 and/or to the second radiator element 120.

In an embodiment, signal feed element 104 is galvanically coupled to the first radiator element 110, wherein the signal feed element 104 penetrates the plane 100, and wherein at least a part of the signal feed element 104 is arranged on the side of the plane 100 on which the second radiator element 120 is arranged on. In FIG. 2A, the signal feed element 104 may be illustrated with a dotted line meaning that the signal feed element may at least partially be on the opposite side of the plane 100 compared with the first radiator element 110.

Still referring to FIGS. 2A to 2B, a part of the signal feed element 104 may be arranged on the same side of the plane 100 compared with the second radiator element 120, as described above. This may mean, for example, fixing or printing said part of the signal feed element 104 on the plane 100. Said part of the signal feed element 104 and the second radiator element 120 may adapted, dimensioned and situated so that there is a space between said part of the signal feed element 104 and the second radiator element 120. Having the space between the signal feed element 104 and the second radiator element 120 may be beneficial as the antenna radiator may cause interference to the signal feed element 104 and/or the signal feed element 104 may cause interference to the antenna radiator. More particularly, the interference may be caused to the second antenna radiator element 120 by the signal feed element 104, and vice versa.

Further, even though the signal feed element 104, or more particularly, said part of the signal feed element 104 may be on the plane 100 so that the first radiator element 110 may at least partially against the signal feed element 104, the electrical insulation by the plane 100 and/or thickness of the plane 100 may have an effect on design of the signal feed element 104. That is, when the thickness and/or electric insulation capability of the plane 100 increases, the signal feed element 104 may be wider, and vice versa. Other way around, when the thickness and/or electric insulation capability of the plane 100 decreases, the signal feed element 104 may be narrower. This is something that may need to be taken into consideration when designing the antenna structure.

The interference reduction may be enhanced when the amount of lead-through elements is increased as this may cause the electrical field within the plane 100 to be closer to zero in a designed frequency. For example, distance of λ/8 between the lead-through elements 102 may be used. When a broadband antenna is used, the λ may be the highest frequency designed for the broadband antenna. That is, when the antenna radiator is designed to operate as the broadband antenna. In the example of FIGS. 2A and 2B, the distance between lead-through elements 102 may mean a distance from one lead-through element to the next closest lead-through element, for example.

In different parts of the antenna, the distance between lead-through elements 102 may be different and/or vary. For example in the throat area of the Vivaldi type antenna resonator a denser lead-through placement may be used than, for example, in a leg of the Vivaldi type antenna resonator. This may mean that more lead-through elements 102 are used on the throat area compared to other areas of the antenna radiator, for example. The throat area may mean the area on which majority of the radiated frequencies are generated. In an embodiment, as shown in FIG. 2A, said part of the signal feed element 104 is arranged so that the first radiator element 110 and said part of the signal feed element 104 are at least partially on top of each other, and at least physically separated by the plane 100. Thus, the signal feed element 104 may be substantially electrically isolated both from the first radiator element 110, caused by the dielectric plane 100, and from the second radiator element 120, caused by the space between the signal feed element 104 and the second radiator element 120.

In an embodiment, shown for example in FIG. 2B, the plurality of lead-through elements 102 are arranged along at least one edge area of the second radiator element 120. Using this approach may be a one way to achieve good symmetry between the first and second radiator elements 110, 120. In such case, the second radiator element 120 may be dimensioned to be smaller than or as large as the first radiator element 110. Thus, if the two radiator elements 110, 120 are of same size, meaning that they cover same sized area, the plurality of lead-through elements 102 may be also situated along at least one edge area of the first radiator element 110.

As shown in FIG. 2B, the second radiator element 120 may comprise two sub-parts both having an edge area. The plurality of lead-through elements 102 are shown to be situated on said edge areas of the sub-parts in FIG. 2B. It is possible, however, that there are also sub-part(s) of the second radiator element 120 that do not necessarily comprise lead-through element(s) 102 on edge area(s) of said sub-part(s) and/or do not comprise lead-through element(s) 102 at all.

In an embodiment, an edge area of the second radiator element 120, or an edge area of a sub-part of the second radiator element may be an area that is outlined by outer edges of a virtual element 206 and inner edges of the second radiator element 120. The edge area may also be the area outlined by the outer edges of the virtual element 206 and the sub-part of the second radiator element 120. The edge area may mean an area that is comprised in the second radiator element 120 and/or the sub-part of the second radiator element 120. Thus, areas between the virtual element 206 and the second radiator element 120 are not necessarily edge areas as they are not necessarily outlined by the virtual element 206 and the second radiator element 120. In the example of FIG. 2B, the outer edges of the virtual element 206 and inner edges of the sub-part of the second radiator element 120, shown with an arrow 208, may not outline anything. However, similar virtual element within the sub-part, indicated with the arrow 208, may be defined as was defined to the sub-part of the second radiator element 120, shown with an arrow 210.

The virtual element 206 may be, for example, shaped substantially the same as the second radiator element 120 and/or sub-part of the second radiator element 120. Further, the virtual element 206 may be within the inner borders of the second radiator element 120 and/or sub-part of the second radiator element 120. The virtual element 206 may be arranged so that its center is substantially aligned with a center of the second radiator element 120 and/or a center of a sub-part of the second radiator element. It needs to be understood that the virtual element 206 is only drawn for illustration purposes and is not an actual part of the antenna structure.

The virtual element 206 may be, for example, at least 95% of the size of the second radiator element 120 and/or sub-part of the second radiator element 120. In an embodiment, the virtual element 206 is at least 90% of the size of the second radiator element 120 and/or sub-part of the second radiator element 120. In an embodiment, the virtual element 206 is at least 80% of the size of the second radiator element 120 and/or sub-part of the second radiator element 120. In an embodiment, the virtual element 206 is at least 50% of the size of the second radiator element 120 and/or sub-part of the second radiator element 120.

In an embodiment, the plurality of lead-through elements 102 are arranged along an edge of the second radiator element 120. As the radiator elements 110, 120 may then be galvanically coupled along the edge, the antenna radiator may be symmetrized, and the antenna radiation pattern may be enhanced. For example, with Vivaldi-type antennas majority of electromagnetic radiation may be formed close to the edges of the radiator elements 110, 120. More particularly, the radiation may be formed in a throat of the radiator elements 110, 120. Thus, it may be beneficial to symmetrize the edges of the radiator elements, or at least the edge areas of the throat of the radiator elements 110, 120. The throat of the radiator element 110 may be shown with an arrow 220 in FIG. 2A. The throat may extend to sides of the radiator elements 110, 120 as is shown in FIG. 2A.

Still referring to FIG. 2A to 2B, the plane 100 plane may comprise at least one circuit board, wherein the first and second radiator elements 110, 120 are printed on the at least one circuit board. The plane 100 may thus be, for example, a multilayer circuit board or a circuit board comprising only one circuit board. The printing material, used to print for example the first and second radiator elements 110, 120, may be electrically conductive material, such as metallic material (i.e. copper). Further, a cover, such as a tin cover, may be printed on the printed first and second radiator elements 110, 120 and/or to any other element printed on the plane 100.

In an embodiment, as shown in FIG. 2B, the antenna structure comprises at least one impedance converter 204 being planar, wherein the at least one impedance converter 204 is arranged on at least one side of the plane 100. The at least one impedance converter 204 may be arranged on the side of the plane that comprises the second radiator element 120, for example.

In an embodiment, there is provided an antenna comprising at least one circuit board comprising at least one antenna radiator. The at least one circuit board may further comprise the at least one impedance converter 204, wherein the at least one impedance converter 204 may be, for example, printed on the at least one circuit board.

Impedance converters may be used to alter configuration of the antenna. Impedance converters may be comprised in separate antenna elements and thus are not normally comprised close to the radiator elements 110, 120. However, it may be beneficial to arrange the at least one impedance converter 204 on the plane 100 as space may be saved and/or amount of antenna elements may be reduced, and thus the antenna structure may become smaller.

In an embodiment, the at least one impedance converter 204 is a part of the signal feed element 104. For example, the signal feed element 104 may be widened to form the at least one impedance converter 204. This may be shown in FIG. 2B.

The implementation of the at least one impedance converter 204 on the plane 100 may be enabled by the dimensions of the second radiator element 120. There may be a space between the at least one impedance converter 204 and the second radiator element 120, as shown in FIG. 2B. Thus, it may be beneficial to make the second radiator element 120 smaller compared to the first radiator element 110 so that there may be space on the plane for other elements, such as the at least one impedance converter 204 and/or the signal feed element 104. As described earlier, the second radiator element 120 may be dimensioned so that it comprises parts of the antenna radiator that provide the majority of the radiated electromagnetic energy.

In an embodiment, the at least one impedance converter 204 is printed on the at least one circuit board comprised in the plane 100. The at least one impedance converter 204 may be printed using an electrically conductive material.

In an embodiment, shown in FIG. 1B, the first antenna radiator element 110 and/or the second antenna radiator element 120 comprises at least one element 152 which is adapted and dimensioned to change impedance of the signal feed element 104. For example, the at least one element 152 may be a part of the second antenna radiator element 120 (i.e. galvanically coupled with the second antenna radiator element). The at least one element 152 may be arranged (i.e. printed) in vicinity of the signal feed element 104 in order to change the impedance of the signal feed element 104. Thus, the first antenna radiator element 110 and/or the second antenna radiator element 120 may act itself as an impedance converter. Further, the at least one element 152 may be electrically grounded (e.g. be in electrical ground potential), and thus the at least one element 152 may be arranged to bring ground potential in vicinity of the signal feed element 104. The in vicinity may mean that the at least one element 152 has a substantial effect on the impedance of the signal feed element 104. There may be a space between the signal feed element 104 and the at least one element 152.

In an embodiment, the signal feed element 104 is arranged on the plane 100 such that it has substantially uniform width. This may mean that the width of the signal feed element 104 does not substantially change. By changing the width at some part of the signal feed element 104, the impedance of the signal feed element 104 may be changed. Thus, when the signal feed element 104 may have the substantially uniform width, the impedance may be changed, for example, by using the at least one element 152.

In an embodiment, a distance between the first radiator element 110 and the signal feed element 104 is configured such that the impedance of the signal feed element 104 is changed. For example, the plane 100 may be thinner from the areas on which signal feed element 104 is arranged on. Thus, the impedance of the signal feed element 104 may be changed by the first radiator element 110.

In an embodiment, the at least one element 152 comprises at least one of the lead-through elements 102. Thus, if the at least element 152 may be electrically coupled with the opposite side of the plane 100. For example, the at least one element 152 may be galvanically coupled with the first radiator element 110 by the lead-through element(s) 102. Naturally, this electrical coupling may enable the at least one element 152 to be in ground potential.

FIGS. 3A to 3B illustrate some embodiments. Referring to FIG. 3A to 3B, the radiator elements 110, 120 may be shown on their respective sides of the plane 100. The parts 301A, 301B of the first radiator element 110 may illustrate the areas that produce the most of the radiated electromagnetic energy by the first radiator element 110. Similarly, the second radiator element 120 may comprise the parts 302A, 302B which may correspond and/or be similar to the parts 301A, 301B.

The first radiator element 110 may be galvanically coupled to ground from at least one grounding 306. Thus, the first radiator element 110 may comprise a grounding level that may be below the line 304 shown in FIG. 3A. As the first and second radiator elements 110, 120 may also be galvanically coupled together, the second radiator element 120 may comprise the same grounding level 304. Thus, the antenna radiator may have a signal feed and a ground level, and may thus work as an antenna, such as a Vivaldi antenna.

In an embodiment, the first and the second radiator elements 110, 120 each comprise a resonant area 301A, 301B, 302A, 302B, wherein the resonant areas 301A, 301B of the first antenna radiator and the resonant areas 302A, 302B second radiator element produce majority of the radiation of the antenna radiator, and wherein at least said resonant areas 301A, 301B, 302A, 302B are substantially identical. Substantially identical in this particular example may mean that the radiation area, formed by the areas 301A, 301B, may be substantially identical compared with a radiation area formed by the areas 302A, 302B.

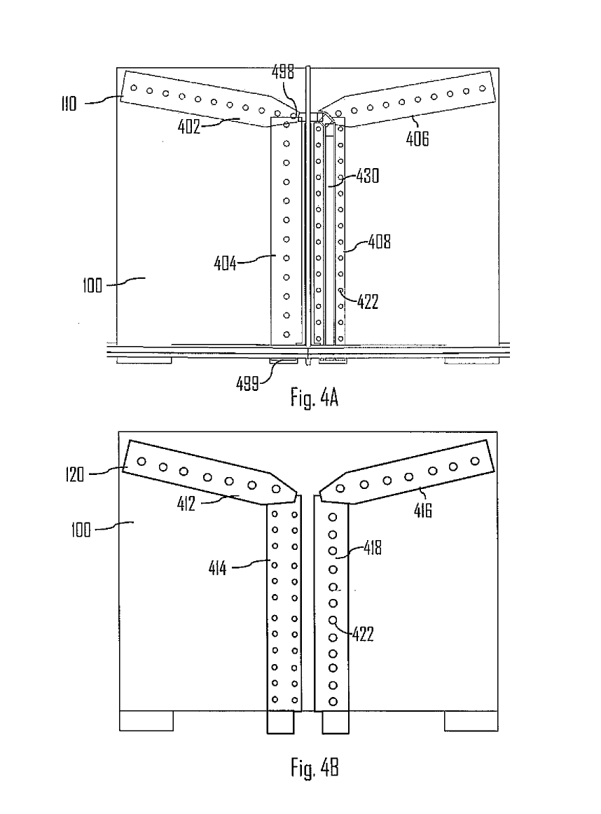

FIGS. 4A to 4B illustrate a two-sided dipole antenna structure according to an embodiment of the invention. Referring to FIGS. 4A to 4B, the antenna structure may be arranged on opposite sides of the plane 100. The first radiator element 110 may comprise a first branch 402, 404 and a second branch 406, 408. The first branch 402, 404 and the second branch 406, 408 may be galvanically coupled to same grounding and/or separate groundings having the same ground potential.

Signal feed to the radiator may be now done using a dipole feeding element 430. The dipole feeding element 430 may be spaced apart from the first and second branches 402, 404, 406, 408. The dipole feeding element 430 may be galvanically coupled with at least one of the first and second branches 402, 404, 406, 408. In the example of FIG. 4A, the dipole feeding element 430 may be arranged at least partially between two parts of the second branch 406, 408, and spaced apart from said parts. Thus, the dipole feeding element 430 may not substantially interfere with the antenna radiator.

The grounding of the dipole antenna structure may be beneficial to be made around ¼ λ distance from the point wherein the dipole feeding element 430 is coupled to the first branch 402, 404, for example. The distance may be measured along the dipole radiator. Thus, in the example of FIG. 4A, the ¼ λ distance from point 498, which may be the point where the dipole feeding element 430 is galvanically coupled to the first branch 402, 404, may be circa on point 499. Naturally, the beneficial grounding point may be affected by the frequency of the transmission.

In an embodiment, the dipole antenna structure is grounded from the part 402 and/or part 406. These parts 402, 406 may produce majority of radiated energy. Grounding the dipole antenna structure from the area of the radiator may be beneficial especially in a case, wherein the dipole antenna structure is used as a broadband antenna.

Looking at FIG. 4B, corresponding dipole antenna elements may be seen on the opposite side of the plane 100. The second radiator element 120 may comprise a third branch 412, 414 and a fourth 416, 418. For example, the third branch 412, 414 may be corresponding to the second branch 406, 408, and the fourth branch 416, 418 may be corresponding to the first branch 402, 404. The third and second branches 412, 414, 406, 408, and the fourth and first branches 416, 418, 402, 404 may be galvanically coupled together using plurality of lead-through elements 422, wherein plurality of lead-through elements 422 may be similar to the plurality of lead-through elements 102. It needs to be noted that the plurality of lead-through elements 422 may be arranged so that the dipole feeding element 430 may not be galvanically coupled to the third branch 412, 414 using the plurality of lead-through elements 422.

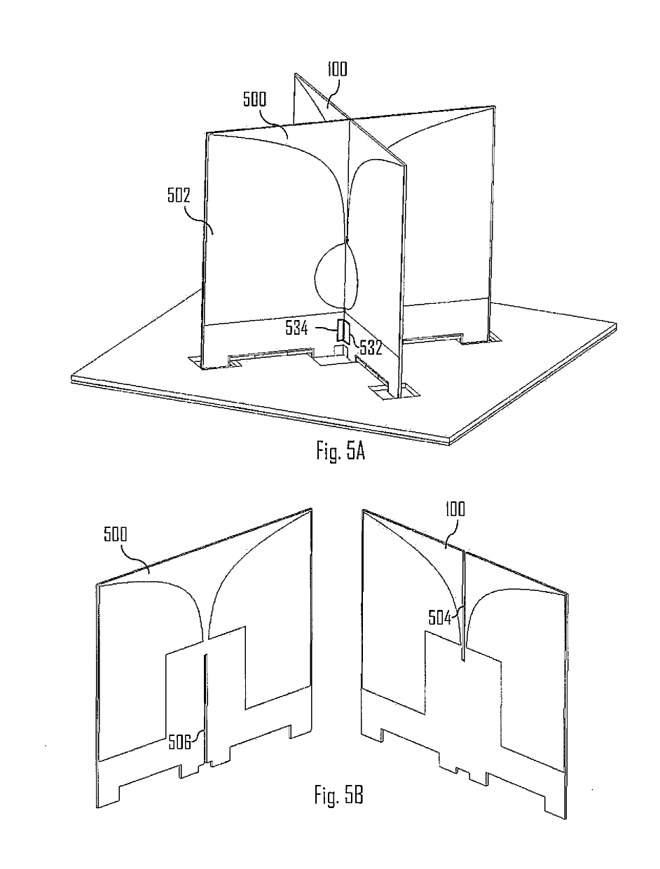

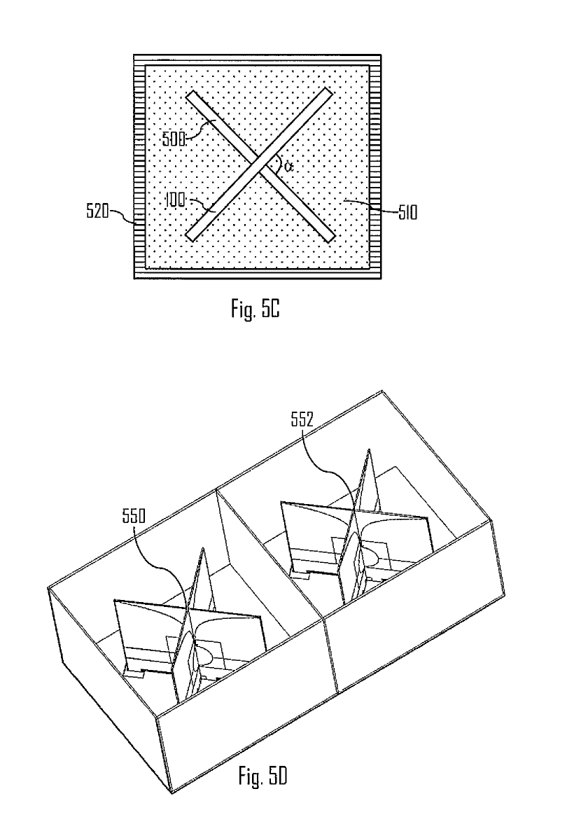

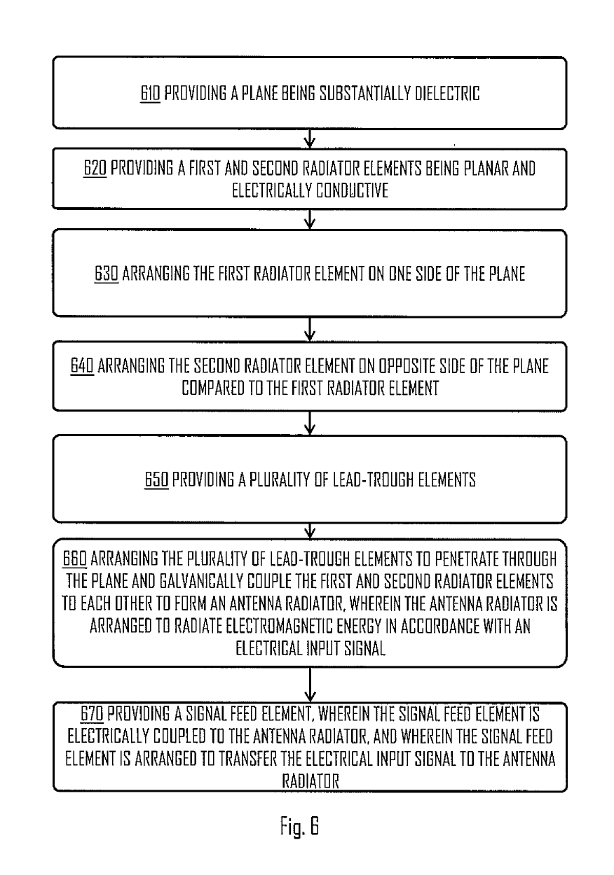

FIGS. 5A to 5D illustrate some embodiments. Referring to FIG. 5A, the plane 100 may be referred to as a first plane 100 of the antenna structure, wherein the antenna structure further comprises: a second plane 500 being substantially dielectric, a third radiator element 502 being planar and electrically conductive, wherein the third radiator element is arranged on one side of the second plane 500, and a fourth radiator element (not shown in FIG. 5A), being planar and electrically conductive, wherein the fourth radiator element is arranged on opposite side of the second plane 500 compared to the third radiator element 502, wherein the third and fourth radiator elements are galvanically coupled to form a second antenna radiator arranged to radiate electromagnetic energy in accordance with an electrical input signal. Thus, the second antenna radiator and its base (e.g. the second plane 500) may be substantially identical. For example, the antenna radiators may both form a Vivaldi and/or a dipole antenna radiator individually.

In an embodiment, the second plane 500 is similar to the plane 100. That is, embodiments described in relation to the first plane 100 comprising the antenna radiator may be used with the plane 500 and the second antenna radiator. In an embodiment, the first plane 100 and the second plane 500 are substantially identical. Further, the antenna radiators may be substantially identical. In an embodiment, the first and third antenna radiator elements are substantially identical. In an embodiment, the second and fourth antenna radiator elements are substantially identical.

In an embodiment, the first and second antenna radiators use the same electrical input signal. It may however be possible that separate inputs are used.

The first and the second planes 100, 500 may be arranged to at least partially intersect with each other, as shown in FIG. 5A. Referring to FIGS. 5A to 5B, the first and/or second planes 100, 500 may comprise a recess 506 enabling the planes 100, 500 to be arranged on top of each other so that the planes 100, 500 are at least partly intersecting with each other. Further, the planes 100, 500 may comprise at least two recesses 506, 504 that are dimensioned and arranged to be but against each other. Using one or more recesses 506, 504, the planes 100, 500 may be arranged to be at least partially intersecting each other so that the first plane 100 may extend from one side of the second plane 500 to the opposite side of the second plane, and vice versa. One example of such intersecting may be clearly seen from FIG. 5A.

In an embodiment, the first and second planes 100, 500 are intersecting each other substantially perpendicular. Thus, the angle between the first and second planes 100, 500, measured from one plane to the other plane at the intersection, may be around 90 degrees.

In an embodiment, the first and second planes are intersecting each other at least on substantially central areas of the first and the second planes 100, 500. As shown in FIG. 5A, both sides of the first plane 100 may be substantially of equal size, wherein said sides are separated by the second plane 500. Similarly, sides of the second plane 500 may be substantially of equal size, wherein said sides are separated by the first plane 100. Thus, as seen in FIG. 5C, the first and second planes 100, 500 may form a cross-shape when illustrated from a bird's eye view. Angle α may be around 90 degrees.

In an embodiment, shown in FIG. 5A for example, the antenna radiator, formed by the first and second radiator elements 110, 120 and arranged to the first plane 100, is a first antenna radiator, wherein the first and second antenna radiators are galvanically coupled so that the first and second antenna radiators have substantially same ground potential. The galvanic coupling may be done in the antenna radiators using at least one coupling member 532, 534. In the example of FIG. 5A, a first coupling member 532 is arranged (i.e. printed) on the first plane 100, and a second coupling member 534 is arranged (i.e. printed) on the second plane 500. Further, the first and second coupling members are connected to each other by using an additional substance and/or by intersecting the first and second planes 100, 500 such that the first and second coupling members 532, 534 are physically touching each other. Even though, the first and second antenna radiators would be grounded individually, as shown in FIG. 3A for example, it may be beneficial to unite groundings of the first and second antenna radiators from parts of the antenna radiator that are closer to the parts that produce the majority of the radiation.

In an embodiment, the first and second antenna radiators are galvanically coupled together when the planes 100, 500 are intersecting each other.

The first and second antenna radiators may form a cross-polarized antenna. This may mean that the separate antenna elements, such as the first and second antenna radiator when arranged together, may form the cross-polarized antenna. In an embodiment, using the galvanic connection between the first and the second antenna radiators enables forming the cross-polarized antenna.

The cross-polarized antenna may be fed using one or more signal feed elements, such as the signal feed element 104. By constructing the cross-polarized antenna radiator, such as the cross-shaped antenna shown in FIG. 5C for example, as proposed by the invention, may enhance the cross-polarized antenna's performance.

Firstly, as the cross-polarized antenna radiator may be formed from, for example, separate antenna radiators (i.e. first and second antenna radiators) the isolation between the separate antenna radiators may be increased.

Secondly, using the proposed galvanic connection (e.g. lead-through elements 102) between the first and second antenna radiator elements 110, 120 may enhance cross polarization discrimination (XPD) value of the first antenna radiator in the cross-polarized antenna. Similarly, XPD of the second antenna radiator may be enhanced in the cross-polarized antenna, when the third and fourth antenna radiator elements are galvanically coupled together as proposed by the invention.

Therefore, both isolation between the first and second antenna radiators and the XPD of the first and second antenna radiators may be enhanced when the first and second antenna radiators are used as elements in the cross-polarized antenna.

It needs to be further noted that XPD value of an antenna radiator, such as the first antenna radiator of FIG. 1 and/or the second antenna radiator, may be enhanced when the lead-troughs, such as the lead-through elements 102, are used as described above. Therefore, the XPD value of the antenna radiator may be enhanced in a solution where one or more antenna radiators are used. Thus, enhancing XPD may not necessarily require two antenna radiators arranged, for example, as shown in FIG. 5C. This may mean that the XPD of, for example, the first antenna radiator may be enhanced using the lead-through elements 102 as described above.

Enhancing the XPD of, for example, the first antenna radiator, formed by the first and second radiator elements 110, 120, may mean that the XPD value gets closer to infinite. This may mean that the linear polarization of the first antenna radiator is enhanced. When XPD gets closer to zero dB, the radiation pattern of the first antenna radiator may be more circular.

In an embodiment, the thickness of the first plane 100 and/or the second plane 500 is around 0.8 millimeters (mm). The thickness may be, for example, between 0.5 mm and 1 mm, between 1 mm and 1.5 mm, or between 1.5 mm and 2.0 mm.

Still referring to FIG. 5C, the antenna structure may comprise a reflector 510 galvanically isolated from the antenna radiator and/or the second antenna radiator, wherein the reflector 510 is arranged to reflect electromagnetic energy resonated by the antenna radiator and/or the second antenna radiator. The reflector 510 and/or at least one wall 520 may be used in an antenna structure comprising the first plane 100, or the first and the second planes 100, 500.

The at least one wall 520, comprised in the antenna structure, may be substantially perpendicular in relation to the reflector 510, wherein the at least one wall 520 is arranged to at least partially surround the antenna radiator and/or the second antenna radiator. Thus, the first plane 100 and/or the second plane 500 may be encircled by the at least one wall 520.

The at least one wall 520 may enhance directivity of the antenna structure by directing (i.e. reflecting) radiated energy towards desired direction. Similarly, the reflector 510 may direct radiated energy towards the desired direction and/or the at least wall 520. The desired direction may be, in the example of FIG. 5C, the direction that is facing the reflector 510. Thus, the radiated energy is desired to go towards a direction that is opposite of the direction where the reflector 510 is located at in relation to the radiation source.

In an embodiment, the antenna structure comprises a second signal feed element configured to provide the second antenna radiator an electrical input signal. The electrical input signal may be same as for the first antenna radiator and/or different. The second signal feed element may be similar and/or identical as the signal feed element 104. For example, the second signal feed element may comprise at least one impedance converter.

Referring to FIG. 5D, a multi-antenna structure may comprise more than one antenna structures 550, 552, wherein each of the more than one antenna structures may be arranged in a casing and surrounded by walls. The multi-antenna structure may be used in a base station to enhance directivity by, for example, using more than one antenna structure for one transmission. The antennas 550, 552 of the multi-antenna structure may be galvanically coupled to each other and/or to an adder element (i.e. combiner element, sum network), wherein the adder element may comprise one or more impedance converters and be electrically connected to a radio signal output and/or input.

There is also provided a method of manufacturing the antenna structure, the method comprising: providing a plane being substantially dielectric (step 610); providing a first and second radiator elements being planar and electrically conductive (step 620); arranging the first radiator element on one side of the plane (step 630); arranging the second radiator element on opposite side of the plane compared to the first radiator element (step 640); providing a plurality of lead-trough elements (step 650); arranging the plurality of lead-trough elements to penetrate through the plane and galvanically couple the first and second radiator elements to each other to form an antenna radiator, wherein the antenna radiator is arranged to radiate electromagnetic energy in accordance with an electrical input signal (step 660); and providing a signal feed element, wherein the signal feed element is electrically coupled to the antenna radiator, and wherein the signal feed element is arranged to transfer the electrical input signal to the antenna radiator (step 670).

In an embodiment, the signal feed element 104 is capacitively coupled with the antenna radiator(s), such as the first antenna radiator and/or the second antenna radiator. In such case, the signal feed element 104 may be coupled with the first antenna radiator and/or the second antenna radiator through air-interface. Thus, the signal feed element 104 may be situated, dimensioned and adapted so that it is not touching the first antenna radiator and/or the second antenna radiator. In an embodiment, at least two capacitively connecting signal feed elements are used. For example, for the first antenna radiator one or more signal feed elements may be used. Similarly, one or more capacitively connectable signal feed elements may be used to transfer the input signal to the second antenna radiator.

In an embodiment, the first antenna radiator and the second antenna radiator are identical. In an embodiment, the first and second radiator elements 110, 120 are identical. Similarly, third and fourth radiator elements may be identical. This may be possible, for example, if the signal feed is achieved using the capacitive connection, as then there may not be a need to have space on the first plane 100 and/or the second plane 500 for the signal feed element 104 and/or the second signal feed element.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An antenna structure comprising:
a plane being substantially dielectric;
a first radiator element being planar and electrically conductive, wherein the first radiator element is arranged on one side of the plane;
a second radiator element being planar and electrically conductive, wherein the second radiator element is arranged on an opposite side of the plane compared with the first radiator element;
a plurality of lead-trough elements penetrating through the plane and galvanically coupling the first and second radiator elements to each other, in order to form an antenna radiator, wherein the antenna radiator is arranged to radiate electromagnetic energy in accordance with an electrical input signal; and
a signal feed element electrically coupled to the antenna radiator, wherein the signal feed element is arranged to transfer the electrical input signal to the antenna radiator.

2. The antenna structure of claim 1, wherein the signal feed element is arranged to penetrate the plane, and wherein the signal feed element is galvanically coupled to the first radiator element.

3. The antenna structure of claim 1, wherein a part of the signal feed element is arranged on the same side of the plane compared with the second radiator element, and wherein said part of the signal feed element and the second radiator element are adapted, dimensioned and situated so that there is a space between said part of the signal feed element and the second radiator element.

4. The antenna structure of claim 3, wherein said part of the signal feed element is arranged so that the first radiator element and said part of the signal feed element are at least partially on top of each other, and at least physically separated by the plane.

5. The antenna structure of claim 1, wherein the signal feed element is capacitively coupled with the antenna radiator.

6. The antenna structure of claim 1, wherein the plurality of lead-through elements are arranged along at least one edge area of the second radiator element.

7. The antenna structure of claim 1, wherein the plane comprises at least one circuit board, and wherein the first and second radiator elements are printed on the at least one circuit board.

8. The antenna structure of claim 1, further comprising:
at least one impedance converter being planar, wherein the at least one impedance converter is arranged on at least one side of the plane.

9. The antenna structure of claim 8, wherein the at least one impedance converter is printed on the at least one circuit board.

10. The antenna structure of claim 1, wherein the first and the second radiator elements each comprise a resonant area, wherein the resonant areas of the first and second radiator elements produce majority of the radiation of the antenna radiator, and wherein at least said resonant areas are substantially identical.

11. The antenna structure of claim 1, wherein the plane is a first plane of the antenna structure, the antenna structure further comprising:
a second plane being substantially dielectric;
a third radiator element being planar and electrically conductive, wherein the third radiator element is arranged on one side of the second plane; and
a fourth radiator element being planar and electrically conductive, wherein the fourth radiator element is arranged on opposite side of the second plane compared to the third radiator element, wherein the third and fourth radiator elements are galvanically coupled to form a second antenna radiator arranged to radiate electromagnetic energy in accordance with the electrical input signal, and wherein the first and the second planes are arranged to at least partially intersect with each other.

12. The antenna structure of claim 11, wherein the first and second planes are intersecting each other substantially perpendicular.

13. The antenna structure of claim 11, wherein the first and second planes are intersecting each other at least on substantially central areas of the first and the second planes.

14. The antenna structure of claim 11, wherein the antenna radiator, formed by the first and second radiator elements, is a first antenna radiator, and wherein the first and second antenna radiators are galvanically coupled so that the first and second antenna radiators have substantially same ground potential.

15. A method of manufacturing an antenna structure, the method comprising: providing a plane being substantially dielectric;
providing a first and second radiator elements being planar and electrically conductive;
arranging the first radiator element on one side of the plane;
arranging the second radiator element on opposite side of the plane compared to the first radiator element;
providing a plurality of lead-trough elements;
arranging the plurality of lead-trough elements to penetrate through the plane and galvanically couple the first and second radiator elements to each other to form an antenna radiator, wherein the antenna radiator is arranged to radiate electromagnetic energy in accordance with an electrical input signal; and
providing a signal feed element, wherein the signal feed element is electrically coupled to the antenna radiator, and wherein the signal feed element is arranged to transfer the electrical input signal to the antenna radiator.
